(19) United States
(12) Patent Application Publication
(10) Pub. No.: US 2014/0362468 A1
(43) Pub. Date: Dec. 11, 2014

(54) MAGNETIC RECORDING HEAD AND DISK DRIVE WITH THE SAME

(71) Applicant: Kabushiki Kaisha Toshiba, Tokyo (JP)

(72) Inventors: Tomoko Taguchi, Kunitachi-shi (JP); Kenichiro Yamada, Tokyo (JP)

(73) Assignee: Kabushiki Kaisha Toshiba, Tokyo (JP)

(21) Appl. No.: 14/021,874

(22) Filed: Sep. 9, 2013

Related U.S. Application Data
(60) Provisional application No. 61/833,075, filed on Jun. 10, 2013.

(51) Int. Cl. G11B 5/23

(52) U.S. Cl. CPC G11B 5/23
USPC 360/99.08; 360/119.03

(57) ABSTRACT

According to one embodiment, a magnetic recording head of a disk drive includes a main pole configured to produce a recording magnetic field perpendicular to a recording layer of a recording medium, a trailing shield located on the trailing side of the main pole with a write gap therebetween, a recording coil configured to produce a magnetic field in the main pole, and a nonmagnetic film containing a nonmagnetic material with a negative thermal expansion coefficient and disposed in the write gap between the trailing shield and a distal end portion of the main pole.

### CROSS-REFERENCE TO RELATED APPLICATIONS

This application claims the benefit of U.S. Provisional Application No. 61/833,075, filed Jun. 10, 2013, the entire contents of which are incorporated herein by reference.

### FIELD

Embodiments described herein relate generally to a magnetic recording head for perpendicular magnetic recording used in a disk drive and the disk device provided with the same.

### BACKGROUND

A disk drive, such as a magnetic disk drive, comprises a magnetic disk, spindle motor, magnetic head, and carriage assembly. The magnetic disk is disposed in a case. The spindle motor supports and rotates the magnetic disk. The magnetic head reads data from and writes data to the magnetic disk. The carriage assembly supports the head for movement relative to the magnetic disk. The magnetic head comprises a slider attached to a suspension of the carriage assembly and a head section on the slider. The head section comprises a magnetic recording head for writing and a reproduction head for reading.

Magnetic heads for perpendicular magnetic recording have recently been proposed in order to increase the recording density and capacity of a magnetic disk drive or reduce its size. In one such magnetic head, a recording head comprises a main pole, write shield, and coil. The main pole produces a perpendicular magnetic field. The write shield is disposed on the trailing side of the main pole with a write gap therebetween and configured to close a magnetic path that leads to a magnetic disk. The coil serves to pass magnetic flux through the main pole. Generally, the write gap portion used to comprise a nonmagnetic film with a positive thermal expansion coefficient.

If the write gap length of the recording head is reduced, the distribution of magnetic fields from the write gap becomes so sharp that the recording resolution of the magnetic disk drive is improved. While the write gap length depends on the thickness of the nonmagnetic film interposed between the main pole and write shield, however, it has recently become difficult to further reduce the film thickness.

### BRIEF DESCRIPTION OF THE DRAWINGS

FIG. 1 is a perspective view showing a hard disk drive (HDD) according to a first embodiment;

FIG. 2 is a side view showing a magnetic head and suspension of the HDD;

FIG. 3 is an enlarged sectional view showing a head section of the magnetic head;

FIG. 4 is a perspective view schematically showing a magnetic recording head of the magnetic head cut away along a track center;

FIG. 5 is a side view of a main pole and nonmagnetic film of the magnetic recording head taken in a track traveling direction;

FIG. 6 is a plan view of the vicinity of a write gap of the magnetic recording head taken from the side of an air-bearing surface (ABS);

FIG. 7 is a sectional view of the magnetic recording head taken along the track center;

FIG. 8 is a sectional view of the magnetic recording head taken along the track center with its recording coil energized;

FIG. 9 is a diagram comparatively showing the relationship between the recording current and bit-error rate for the magnetic recording head according to the first embodiment and a magnetic recording head according to a comparative example;

FIG. 10 is a diagram comparatively showing the relationship between the recording density and normalized output power for the magnetic recording heads according to the first embodiment and comparative example;

FIG. 11 is a sectional view of magnetic recording head of an HDD according to a modification example taken along the track center;

FIG. 12 is a plan view of a magnetic recording head of an HDD according to a second embodiment taken from the ABS side;

FIG. 13 is a front view of the magnetic recording head of the HDD according to the second embodiment;

FIG. 14 is a plan view of the magnetic recording head of the second embodiment with its recording coil energized;

FIG. 15 is a diagram comparatively showing the relationship between the recording current and bit-error rate for the magnetic recording head according to the second embodiment and a magnetic recording head according to a comparative example;

FIG. 16 is a plan view of a magnetic recording head of an HDD according to a third embodiment taken from the ABS side; and

FIG. 17 is a front view of the magnetic recording head of the HDD according to the third embodiment.

### DETAILED DESCRIPTION

Various embodiments will be described hereinafter with reference to the accompanying drawings. In general, according to one embodiment, a magnetic recording head comprises: a main pole configured to produce a recording magnetic field perpendicular to a recording layer of a recording medium; a trailing shield on a trailing side of the main pole with a write gap therebetween; a recording coil configured to produce a magnetic field in the main pole; and a nonmagnetic film containing a nonmagnetic material with a negative thermal expansion coefficient and disposed in the write gap between the trailing shield and a distal end portion of the main pole.

### First Embodiment

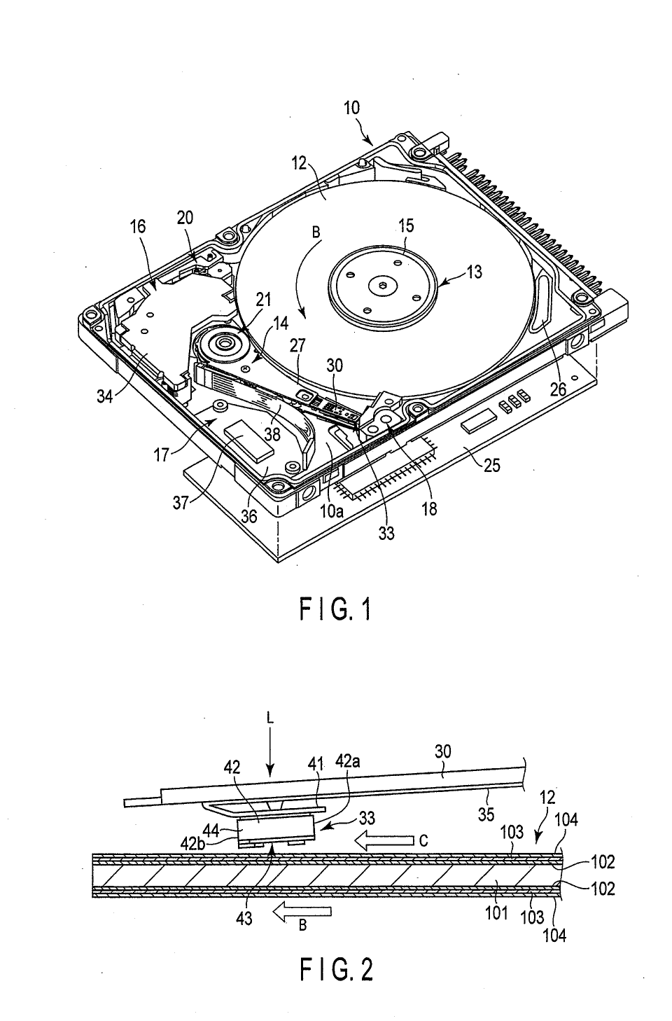

FIG. 1 shows the internal structure of an HDD according to a first embodiment with its top cover removed, and FIG. 2 shows a flying magnetic head. As shown in FIG. 1, the HDD comprises a housing 10. The housing 10 comprises a base 10a in the form of an open-topped rectangular box and the top cover (not shown) in the form of a rectangular plate. The top cover is attached to the base by screws so as to close the top opening of the base. Thus, the housing 10 is kept airtight inside and can communicate with the outside through a breather filter 26 only.

The base 10a carries thereon a magnetic disk 12, for use as a recording medium, and a drive unit. The drive unit comprises a spindle motor 13, a plurality (for example, two) of magnetic heads 33, head actuator 14, and voice coil motor (VCM) 16. The spindle motor 13 supports and rotates the magnetic disk 12. The magnetic heads 33 record and reproduce data in and from the disk. The head actuator 14 supports the heads 33 for movement relative to the surface of the disk 12. The VCM 16 pivots and positions the head actuator. The base 10a further carries a ramp loading mechanism 18, latch mechanism 20, and board unit 17. The ramp loading mechanism 18 holds the magnetic heads 33 in positions off the magnetic disk 12 when the magnetic heads 33 are moved to the outermost periphery of the disk. The latch mechanism 20 holds the head actuator 14 in a retracted position if the HDD is jolted, for example. Electronic components, such as a conversion connector, are mounted on the board unit 17.

A printed circuit board 25 is attached to the outer surface of the base 10a by screws so as to face the bottom wall of the base. The circuit board 25 controls the operations of the spindle motor 13, VCM 16, and magnetic heads 33 through the board unit 17.

As shown in FIG. 1, the magnetic disk 12 is coaxially fitted on the hub of the spindle motor 13 and clamped and secured to the hub by a clamp spring 15, which is attached to the upper end of the hub by screws. The magnetic disk 12 is rotated at a predetermined speed in the direction of arrow B by the spindle motor 13 for use as a drive motor.

The head actuator 14 comprises a bearing 21 secured to the bottom wall of the base 10a and a plurality of arms 27 extending from the bearing. The arms 27 are arranged parallel to the surfaces of the magnetic disk 12 and at predetermined intervals and extend in the same direction from the bearing 21. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each suspension 30 may be formed integrally with its corresponding arm 27. Each magnetic head 33 is supported on an extended end of its corresponding suspension 30. The arms 27 and suspensions 30 constitute a head suspension, and the head suspension and magnetic heads 33 constitute a head suspension assembly.

As shown in FIG. 2, each magnetic head 33 comprises a substantially cuboid slider 42 and read/write head section 44 on an outflow end (trailing end) of the slider. Each magnetic head 33 is secured to a gimbal spring 41 on the distal end portion of its corresponding suspension 30. Head load L directed to the surface of the magnetic disk 12 is applied to each head 33 by the elasticity of the suspension 30. The two arms 27 are arranged parallel to and spaced apart from each other, and the suspensions 30 and magnetic heads 33 mounted on these arms 27 face one another with the magnetic disk 12 between them.

Each magnetic head 33 is electrically connected to a main flexible printed circuit board (main FPC, described later) 38 through the suspension 30 and a relay FPC 35 on the arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 10a. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 21 in the direction opposite to the arms 27 and a voice coil supported on the support frame. When the head actuator 14 is assembled to the base 10a, the voice coil is located between a pair of yokes 34 that are secured to the base 10a. Thus, the voice coil, along with the yokes 34 and a magnet secured to one of the yokes, constitutes the VCM 16.

If the voice coil of the VCM 16 is energized with the magnetic disk 12 rotating, the head actuator 14 pivots, whereupon each magnetic head 33 is moved to and positioned above a desired track of the magnetic disk 12. As this is done, the head 33 is moved radially relative to the magnetic disk 12 between the inner and outer peripheral edges of the disk.

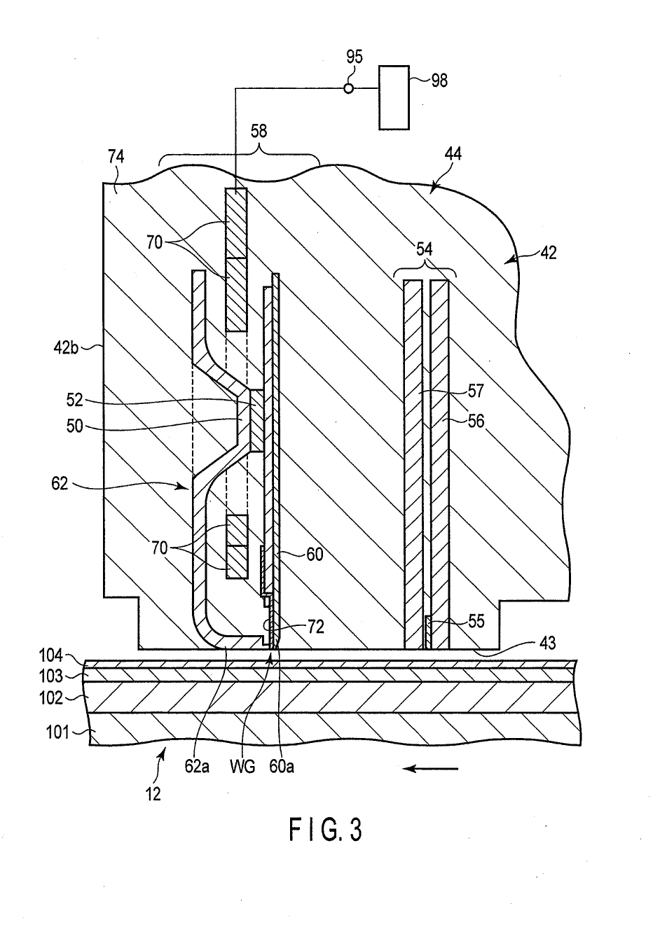

The following is a detailed description of configurations of the magnetic disk 12 and each magnetic head 33. FIG. 3 is an enlarged sectional view showing the magnetic disk and the head section 44 of the magnetic head 33.

As shown in FIGS. 1 to 3, the magnetic disk 12 comprises a substrate 101 formed of a nonmagnetic disk with a diameter of, for example, about 2.5 inches (6.35 cm). A soft magnetic layer 102 for use as an underlayer is formed on each surface of the substrate 101. The soft magnetic layer 102 is overlain by a magnetic recording layer 103, which has a magnetic anisotropy perpendicular to the disk surface. Further, a protective film 104 is formed on the recording layer 103.

As shown in FIGS. 2 and 3, each magnetic head 33 is constructed as a flying head, which comprises the substantially cuboid slider 42 and head section 44 formed on the outflow or trailing end side of the slider. The slider 42 is formed of, for example, a sintered body (AlTic) containing alumina and titanium carbide, and the head section 44 is formed by laminating thin films.

The slider 42 has a rectangular disk-facing surface or air-bearing surface (ABS) 43 configured to face a surface of the magnetic disk 12. The slider 42 is kept floating by airflow C that is produced between the disk surface and the ABS 43 as the magnetic disk 12 rotates. The direction of airflow C is coincident with the direction of rotation B of the magnetic disk 12. The slider 42 is located on the surface of the magnetic disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIG. 3, the head section 44 is formed as a dual-element magnetic head, comprising a reproduction head 54 and recording head (magnetic recording head) 58 formed on the slider 42 by thin-film processing. The reproduction head 54 and recording head 58 are entirely covered by a protective insulating film 74 except for those parts which are exposed in the ABS 43 of the slider 42. The protective insulating film 74 defines the external shape of the head section 44.

The reproduction head 54 comprises a magnetic film 55 having a magnetoresistive effect and shielding films 56 and 57 disposed on the trailing and leading sides, respectively, of the magnetic film such that they sandwich the magnetic film between them. The respective lower ends of the magnetic film 55 and shielding films 56 and 57 are exposed in the ABS 43 of the slider 42.

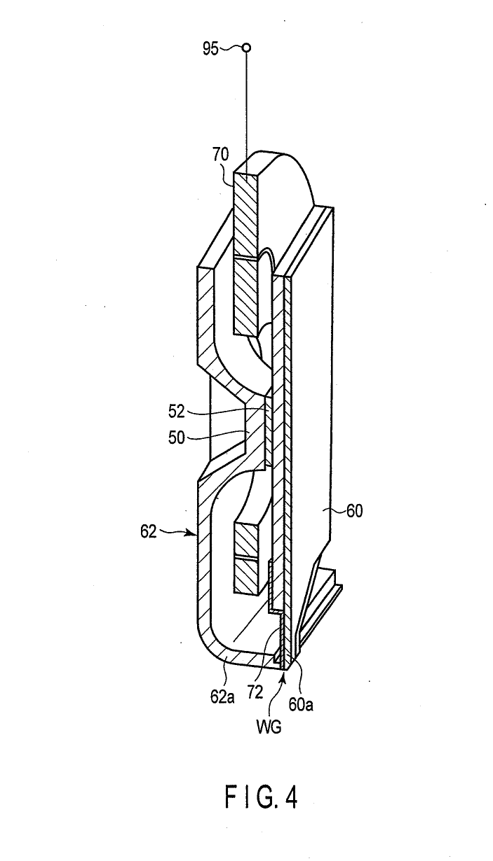

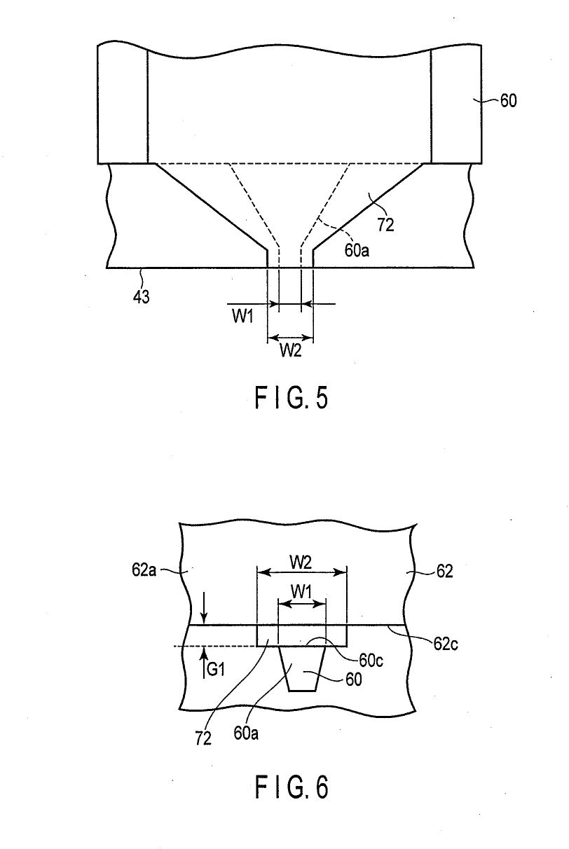

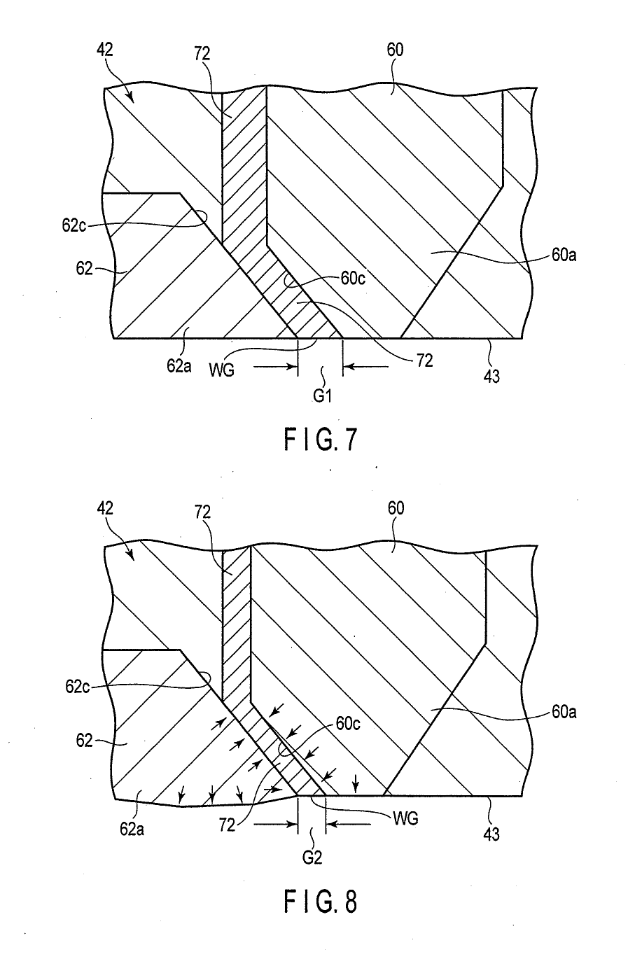

The recording head 58 is located nearer to the trailing end 42b of the slider 42 than the reproduction head 54. FIG. 4 is a perspective view schematically showing the recording head 58 cut away along a track center on the magnetic disk 12. FIG. 5 is a side view of a main pole and nonmagnetic film of the recording head taken in a track traveling direction. FIG. 6 is a plan view of the vicinity of a write gap of the recording head taken from the side of the disk-facing surface (ABS). FIG. 7 is a sectional view of the recording head taken along the track center.

As shown in FIGS. 3 and 4, the recording head 58 comprises a main pole 60 and write shield (trailing shield) 62, which are made of a soft magnetic material with high saturation magnetic flux density, and a recording coil 70. The write shield 62 is located on the trailing side of the main pole 60. The recording coil 70 is disposed so as to get wound around a magnetic circuit comprising the main pole 60 and write shield 62 to pass magnetic flux through the main pole while a signal is being written to the magnetic disk 12. To magnetize the magnetic recording layer 103 of the magnetic disk 12, the main pole 60 produces a recording magnetic field perpendicular to the surface of the magnetic disk 12. The write shield 62 serves to efficiently close a magnetic path by means of the soft magnetic layer 102 just below the main pole 60.

As shown in FIGS. 3 to 6, the main pole 60 extends substantially perpendicular to the ABS 43 and the surfaces of the magnetic disk 12. A distal end portion 60a of the main pole 60 on the disk side is tapered toward the ABS 43 and has the form of a pillar narrower than the other parts of the main pole. The distal end surface of the main pole 60 is exposed in the ABS 43 of the slider 42. Track-direction width W1 of the distal end portion 60a of the main pole 60 is substantially equal to the track width of the magnetic disk 12.

The write shield 62 is substantially L-shaped and comprises a distal end portion 62a opposed to the distal end portion of the main pole 60 and a junction 50 connected to the main pole. The junction 50 is connected to an upper part of the main pole 60 located off the ABS 43 through a nonconductor 52. The distal end portion 62a of the write shield 62 has an elongated rectangular shape. The distal end surface of the write shield 62 is exposed in the ABS 43 of the slider 42. A leading end surface 62c of the distal end portion 62a extends transversely relative to the tracks of the magnetic disk 12. The leading end surface 62c is opposed substantially parallel to a trailing end surface 60c of the main pole 60 with write gap WG (with length G1) therebetween.

In the present embodiment, the trailing end surface 60c of the distal end portion 60a of the main pole 60 extends inclined toward the head trailing side with distance from the magnetic disk 12, with respect to the direction perpendicular to the recording layer of the magnetic disk 12. In other words, the trailing end surface 60c is inclined toward the head trailing side with distance (on the deeper side in the height direction) from the ABS 43, with respect to the direction perpendicular to the ABS.

The leading end surface 62c of the write shield 62 extends inclined toward the head trailing side with distance from the magnetic disk 12, with respect to the direction perpendicular to the recording layer of the magnetic disk 12. In other words, the leading end surface 62c is inclined at a predetermined angle toward the head trailing side with distance (on the deeper side in the height direction) from the ABS 43, with respect to the direction perpendicular to the ABS. Thus, the leading end surface 62c is located substantially parallel to the trailing end surface 60c of the main pole 60 with write gap WG therebetween.

The recording coil 70 is wound around the junction 50 between the main pole 60 and write shield 62, for example. A terminal 95 is connected to the recording coil 70, and a power supply 98 is connected to the terminal 95. Current supplied from the power supply 98 to the recording coil 70 is controlled by a control unit of the HDD. In writing a signal to the magnetic disk 12, a predetermined current is supplied from the power supply 98 to the coil 70 so that magnetic flux is passed through the main pole 60 to produce a magnetic field.

As shown in FIGS. 3 to 7, a nonmagnetic material film 72 (nonmagnetic film) 72 containing a nonmagnetic material with a negative thermal expansion coefficient is disposed in that part of the recording head 58 which corresponds to write gap WG. The nonmagnetic material film 72 is formed overlapping the trailing side of the main pole 60, for example, and extends from a middle portion of the main pole to the ABS 43. The lower end portion of the nonmagnetic material film 72 is embedded in write gap WG and closely contacts the trailing end surface 60c of the main pole 60 and the leading end surface 62c of the write shield 62. The nonmagnetic material film 72 has such a structure that its lower end portion on the ABS side is tapered toward the ABS 43. Track-direction width W2 of that part of the lower end portion of the nonmagnetic material film 72 which is embedded in write gap WG is greater than track-direction width W1 of the distal end portion 60a of the main pole 60. Thus, the nonmagnetic material film 72 contacts the entire trailing end surface 60c of the main pole 60 and extends on both sides of the trailing end surface 60c in the track direction.

The nonmagnetic material film 72 with a negative thermal expansion coefficient may be made of, for example, zirconium tungstate, silicon oxide, iron-nickel alloy, or manganese nitride or Mn₃XN (X: Ge, Sn, etc.). The nonmagnetic film may be formed by being mixed with a nonmagnetic material with a negative thermal expansion coefficient instead of being made of the nonmagnetic material only.

If the VCM 16 is actuated, according to the HDD constructed in this manner, the head actuator 14 pivots, whereupon each magnetic head 33 is moved to and positioned above a desired track of the magnetic disk 12. Further, the head 33 is caused to fly by airflow C that is produced between the disk surface and the ABS 43 as the disk 12 rotates. When the HDD is operating, the ABS 43 of the slider 42 is opposed to the disk surface with a gap therebetween. As shown in FIG. 2, the magnetic head 33 flies with the recording head 58 of the head section 44 inclined to be located close to the surface of the magnetic disk 12. In this state, recorded data is read from the magnetic disk 12 by the reproduction head 54 and data is written by the recording head 58.

In writing data, as shown in FIG. 3, alternating current is supplied from the second power supply 98 to the recording coil 70 so that the main pole 60 is excited by the recording coil, and a perpendicular recording magnetic field is applied from the main pole to the magnetic recording layer 103 of the magnetic disk 12 just below the main pole. In this way, data is recorded with a desired track width on the recording layer 103.

If current is applied to the recording coil 70, as shown in FIGS. 7 and 8, the main pole 60 and write shield 62 are heated and thermally expanded by heat from the recording coil 70 and project from the side of write gap WG and ABS 43 toward the magnetic disk 12. At the same time, the nonmagnetic material film 72 in write gap WG is contracted by the heat, since its thermal expansion coefficient is negative. As a result of the thermal expansion of the magnetic poles and the contraction of the nonmagnetic material film 72, write gap WG is narrowed, and the film thickness is reduced. Specifically, gap length G2 of write gap WG obtained when current is applied to the recording coil 70 is shorter than gap length G1 before the current application to the recording coil 70. If gap length G1 before the current application is, for example, about 25 nm, gap length G2 during the current application is as short as about 20 nm. As write gap WG during the current application is narrowed, the recording resolution of the recording head 58 and linear recording density are improved. Also, the saturation point of the bit-error rate (BER) obtained when the applied current is increased is improved.

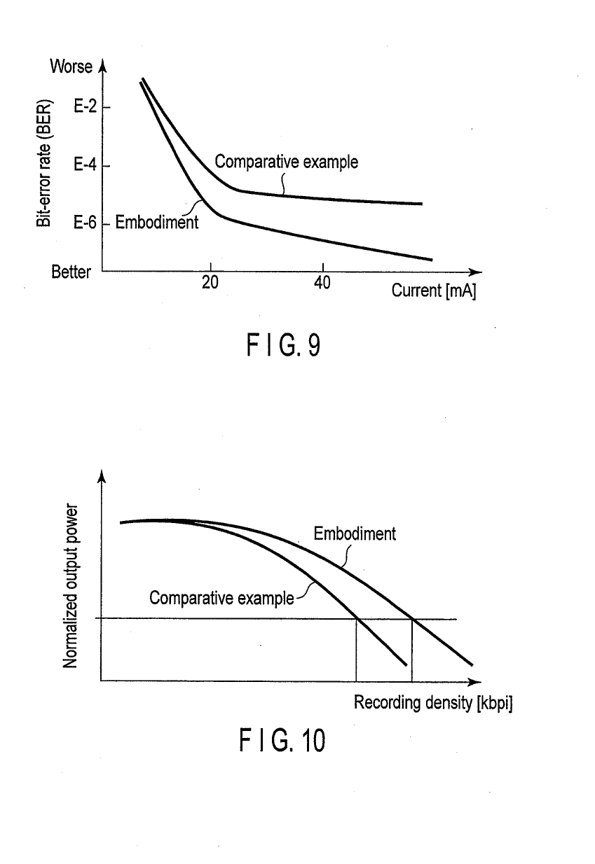

FIG. 9 is a diagram comparatively showing the relationship between the recording current and bit-error rate for the magnetic recording head according to the first embodiment and a magnetic recording head according to a comparative example. FIG. 10 is a diagram comparatively showing the relationship between the recording density and normalized output power for the magnetic recording heads according to the first embodiment and comparative example. In the recording heads according to the first embodiment and comparative example, the main pole and write shield are made of an iron- or cobalt-based alloy. In the recording head according to the comparative example, moreover, a nonmagnetic material film of aluminum oxide (Al₂O₃) or ruthenium with a positive thermal expansion coefficient is assumed to be disposed in a write gap. Write gap length G1 in a de-energized state is equal to that of the recording head according to the first embodiment.

If the nonmagnetic material film is heated by heat produced as current is passed through a recording coil, in the recording head according to the comparative example, the film is thermally expanded and projects from the ABS, although write gap length G1 hardly changes.

In the recording head according to the comparative example, as shown in FIG. 9, although the BER is reduced with increase of the recording current, it is saturated at a certain current. In the recording head according to the present embodiment, the write gap length is reduced with increase of the recording current, so that the recording resolution is improved. Even if the saturation current for the recording head according to the comparative example is exceeded, therefore, the BER continues to be improved (or reduced).

FIG. 10 shows changes of output power in a case where the single-frequency recording density is changed based on a current (for example, 40 mA) that is higher than the critical change point of the BER shown in FIG. 9 such that the BER slowly changes, that is, such a current that the magnetization of the distal end of the recording magnetic pole is saturated so that a sufficient leakage magnetic field is produced from the write gap. The output values shown in FIG. 10 are normalized values that are normalized at the respective low-pass outputs of the recording heads of the comparative example and the present embodiment. In the recording head of the present embodiment, compared with the comparative example, the recording density corresponding to a certain normalized output value is improved, so that the recording resolution is improved, as seen from FIG. 10.

According to the first embodiment, as described above, there may be provided a magnetic recording head, in which the write gap is narrowed during current application so that the recording resolution and linear recording density can be improved, and a magnetic disk device with the same.

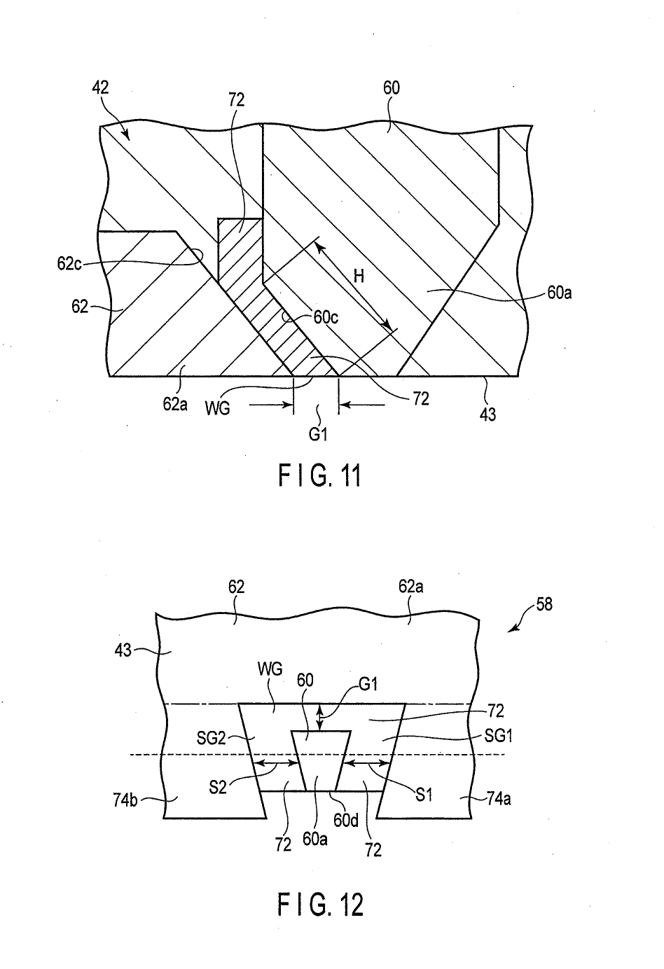

The nonmagnetic material film 72 with a negative thermal expansion coefficient is not limited to that of the first embodiment described above, and may alternatively be provided only in that region of write gap WG which faces the distal end portion 60a of the main pole 60 and the distal end portion 62a of the write shield 62, as shown in FIG. 11. Thus, the nonmagnetic material film 72 is only expected to be provided within a length range of 30% or more of length H of write gap WG from the ABS 43.

The following is a description of magnetic recording heads of HDDs according to alternative embodiments. In the description of these alternative embodiments to follow, like reference numbers are used to designate the same parts as those of the first embodiment, and a detailed description thereof is omitted. The following is a detailed description focused on different parts.

### Second Embodiment

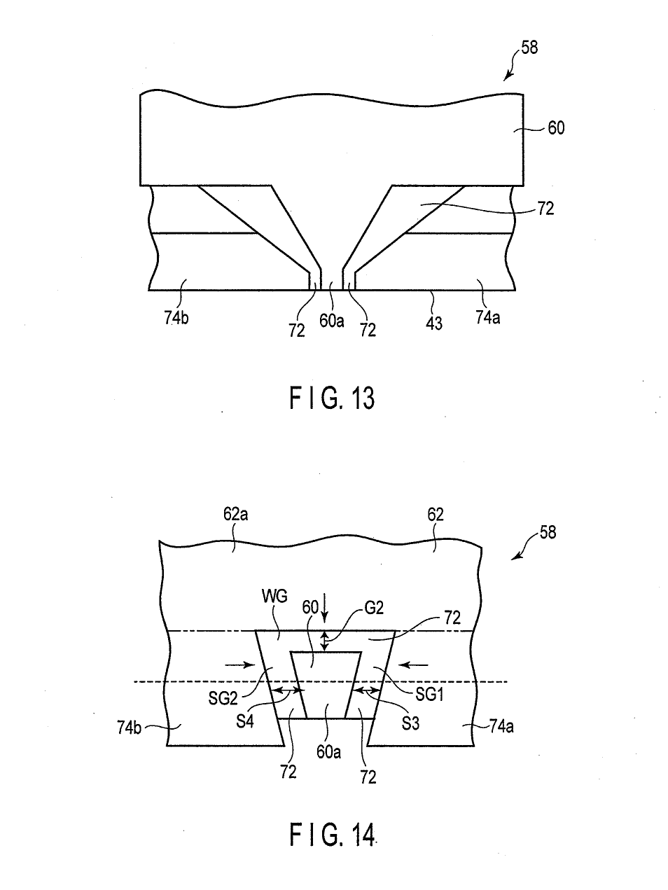

FIG. 12 is a plan view of the distal end portion of a magnetic recording head of an HDD according to a second embodiment taken from the ABS side, and FIG. 13 is a front view of the distal end portion of the magnetic recording head taken in a track traveling direction.

According to the second embodiment, as shown in FIGS. 12 and 13, a recording head 58 of the HDD comprises a main pole 60 of a soft magnetic material with high saturation magnetic flux density, a write shield (trailing shield) 62 of a soft magnetic material, and a recording coil (not shown). The main pole 60 produces a recording magnetic field perpendicular to the surface (or recording layer) of a magnetic disk 12. The write shield 62 is located on the trailing side of the main pole 60 with write gap WG therebetween and serves to efficiently close a magnetic path by means of a soft magnetic layer 102 just below the main pole 60. The recording coil is disposed so as to get wound around a magnetic circuit comprising the main pole 60 and write shield 62 to pass magnetic flux through the main pole while a signal is being written to the magnetic disk 12. The recording head 58 further comprises a pair of side shields 74a and 74b of a soft magnetic material disposed individually on the opposite sides of the main pole 60 in a track-width direction so as to be magnetically separated from the main pole 60 on an ABS 43.

The side shields 74a and 74b are formed integrally with a distal end portion 62a of the write shield 62 and project from the leading end surface of the distal end portion 62a toward the leading end of the slider 42. The side shields 74a and 74b extend from the leading end surface of the write shield 62 to a level position beyond a leading end surface 60d of the main pole 60.

The nonmagnetic material film 72 of the nonmagnetic material with a negative thermal expansion coefficient is disposed in write gap WG between the main pole 60 and write shield 62, gap SG1 (with gap length S1) between the main pole 60 and side shield 74a, and gap SG2 (with gap length S2) between the main pole 60 and side shield 74b. In the vicinity of the ABS 43, the nonmagnetic material film 72 is disposed between the main pole 60 and opposite side shields 74a and 74b. On the deep or upper side relative to the ABS 43, the nonmagnetic material film 72 extends spreading in the track-width direction. The nonmagnetic material film 72 has such a structure that its lower end portion on the ABS side is tapered toward the ABS 43. The track-direction width of the lower end portion of the nonmagnetic material film 72 is greater than that of the distal end portion 60a of the main pole 60.

The nonmagnetic material film 72 with a negative thermal expansion coefficient may be made of, for example, zirconium tungstate, silicon oxide, iron-nickel alloy, or manganese nitride or Mn₃XN (X: Ge, Sn, etc.). The nonmagnetic film may be formed by being mixed with a nonmagnetic material with a negative thermal expansion coefficient instead of being made of the nonmagnetic material only.

If current is applied to the recording coil, as shown in FIG. 14, the main pole 60, write shield 62, and side shields 74a and 74b are heated and thermally expanded by heat from the recording coil, bulge out toward gaps SG1 and SG2, and further project from the ABS 43 toward the magnetic disk 12. At the same time, the nonmagnetic material film 72 in write gap WG and gaps SG1 and SG2 is contracted by the heat, since its thermal expansion coefficient is negative. As a result of the thermal expansion of the magnetic poles and the contraction of the nonmagnetic material film 72, write gap WG and gaps SG1 and SG2 are narrowed, and the nonmagnetic material film 72 is reduced. Specifically, gap length G2 of write gap WG obtained when current is applied to the recording coil is shorter than gap length G1 before the current application to the recording coil. If gap length G1 before the current application is, for example, about 25 nm, gap length G2 during the current application is as short as about 20 nm. At the same time, gap lengths S3 and S4 of gaps SG1 and SG2 during the current application to the recording coil are shorter than gap lengths S1 and S2 before the current application.

As write gap WG and gaps SG1 and SG2 during the current application are narrowed in this manner, the recording resolution of the recording head 58 and linear recording density are improved. Also, the saturation point of the bit-error rate (BER) obtained when the applied current is increased is improved.

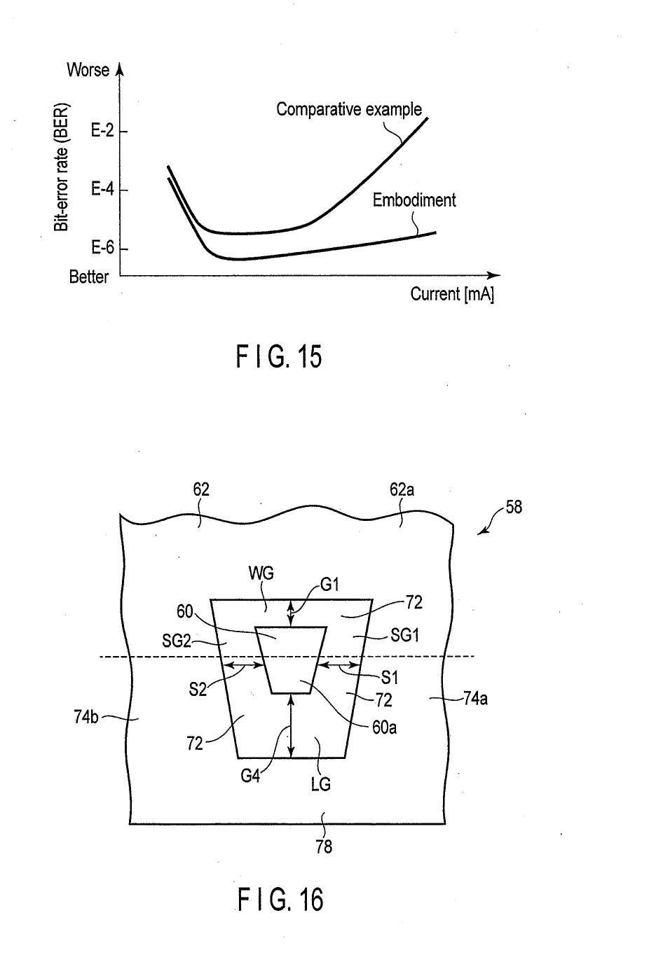

FIG. 15 shows the BER after recording on adjacent tracks obtained as the current applied to the recording coil is increased for the magnetic recording heads according to the second embodiment and a comparative example. The BER after the adjacent-track recording is a BER obtained by measuring a recording signal for an initial track recovered after recording of 100 random signals at a time at a predetermined track pitch with the recording head shifted on both sides in the track-width direction after measurement of an initial BER with a random signal pattern recorded on or reproduced from a certain track on the magnetic disk. Thus, the BER after the adjacent-track recording is an index that is degraded if a leakage magnetic field in the track-width direction is large.

In the recording heads according to the second embodiment and comparative example, the main pole, write shield, and side shields are made of an iron- or cobalt-based alloy. In the recording head according to the comparative example, moreover, a nonmagnetic material film of aluminum oxide (Al₂O₃) or ruthenium with a positive thermal expansion coefficient is assumed to be disposed in a write gap and gaps SG1 and SG2. Write gap length G1 in a de-energized state is equal to that of the recording head according to the second embodiment.

If the nonmagnetic material film is heated by heat produced as current is passed through a recording coil, in the recording head according to the comparative example, the film is thermally expanded and projects from the ABS, although write gap length G1 and gap lengths S1 and S2 hardly change.

In the recording head according to the comparative example, as shown in FIG. 15, the BER after the adjacent-track recording is improved (or reduced) with increase of the recording current passed through the recording coil in a region where the recording current is low. In a region where the recording current is high, however, leakage magnetic field in the track-width direction is so large that the BER after the adjacent-track recording increases.

In the recording head according to the present embodiment, in contrast, the recording resolution is improved as write gap WG is narrowed with increase of the current, so that the degree of improvement (reduction) of the BER becomes higher than in the comparative example. If the current is further increased, the distance (gap) between the main pole and side shields is reduced, so that the leakage magnetic field in the track-width direction is suppressed, and the BER after the adjacent-track recording cannot be easily degraded. Thus, the track recording density can be increased.

According to the second embodiment, as described above, there may be provided a magnetic recording head, in which the write gap and side gaps are narrowed during current application so that the recording resolution, linear recording density, and recording track density can be improved, and a magnetic disk device with the same.

### Third Embodiment

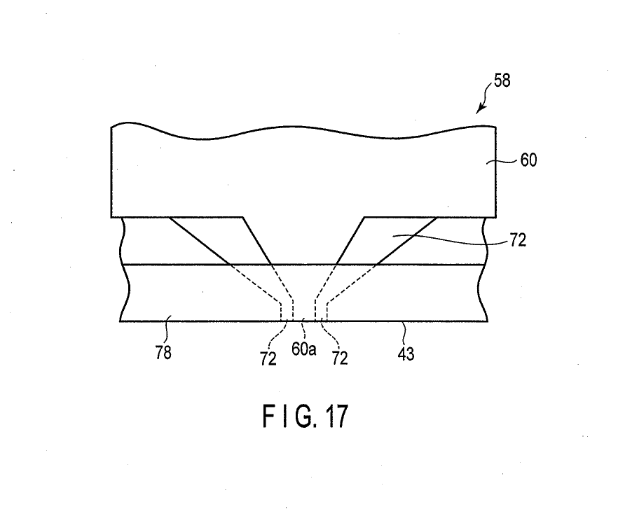

FIG. 16 is a plan view of the distal end portion of a magnetic recording head of an HDD according to a third embodiment taken from the ABS side, and FIG. 17 is a front view of the magnetic recording head.

According to the third embodiment, a recording head 58 of the HDD comprises a main pole 60 of a soft magnetic material with high saturation magnetic flux density, write shield (trailing shield) 62 of a soft magnetic material, a pair of side shields 74a and 74b of a soft magnetic material, and leading shield 78. The write shield 62 is located on the trailing side of the main pole 60 with write gap WG therebetween. The side shields 74a and 74b are disposed individually on the opposite sides of the main pole 60 in a track-width direction so as to be magnetically separated from the main pole 60 on an ABS 43. The leading shield 78 is connected to the side shields 74a and 74b and disposed on the leading side of the main pole 60 with a space therebetween. The leading shield 78 is made of a soft magnetic material and is magnetically separated from the main pole 60 on the ABS 43.

A nonmagnetic material film 72 of a nonmagnetic material with a negative thermal expansion coefficient is disposed in write gap WG between the main pole 60 and write shield 62, gap SG1 (with gap length S1) between the main pole 60 and side shield 74a, gap SG2 (with gap length S2) between the main pole 60 and side shield 74b, and gap LG (with gap length G4) between the main pole 60 and leading shield 78. The ABS-side end of the nonmagnetic material film 72 is exposed in the ABS 43 so as to be substantially flush therewith. On the deep or upper side relative to the ABS 43, the nonmagnetic material film 72 extends spreading in the track-width direction. The nonmagnetic material film 72 has such a structure that its lower end portion on the ABS side is tapered toward the ABS 43. The track-direction width of the lower end portion of the nonmagnetic material film 72 is greater than that of a distal end portion 60a of the main pole 60.

The nonmagnetic material film 72 with a negative thermal expansion coefficient may be made of, for example, zirconium tungstate, silicon oxide, iron-nickel alloy, or manganese nitride or Mn₃XN (X: Ge, Sn, etc.). The nonmagnetic film may be formed by being mixed with a nonmagnetic material with a negative thermal expansion coefficient instead of being made of the nonmagnetic material only.

According to the third embodiment, as described above, there may be provided a magnetic recording head, in which write gap WG, side gaps SG1 and SG2, and leading gap LG are narrowed during current application so that the recording resolution, linear recording density, and recording track density can be improved, and a magnetic disk device with the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes, sizes, etc., of elements that constitute the head section may be changed as required. In the magnetic disk drive, moreover, the numbers of the magnetic disks and magnetic heads can be increased as required, and various disk sizes can be selected.

What is claimed is:

1. A magnetic recording head comprising:
a main pole configured to produce a recording magnetic field perpendicular to a recording layer of a recording medium;
a trailing shield on a trailing side of the main pole with a write gap therebetween;
a recording coil configured to produce a magnetic field in the main pole; and
a nonmagnetic film containing a nonmagnetic material with a negative thermal expansion coefficient and disposed in the write gap between the trailing shield and a distal end portion of the main pole.

2. The magnetic recording head of claim 1, wherein a width of the nonmagnetic film in a track-width direction, in the write gap, is greater than that of the main pole.

3. The magnetic recording head of claim 2, further comprising a facing surface facing the recording medium, wherein a distal end portion of the trailing shield and the distal end portion of the main pole are exposed in the facing surface and define the write gap in the facing surface, and the nonmagnetic film is disposed in the write gap within a positional range corresponding to 30% or more of a length of the write gap from the facing surface.

4. The magnetic recording head of claim 1, further comprising side shields extending from the trailing shield and located individually on both sides of the main pole in a track-width direction with gaps therebetween and a nonmagnetic film containing a nonmagnetic material with a negative thermal expansion coefficient and disposed in the gaps between the main pole and the side shields.

5. The magnetic recording head of claim 4, further comprising a leading shield disposed on a leading side of the main pole with a gap therebetween and a nonmagnetic film containing a nonmagnetic material with a negative thermal expansion coefficient and disposed in the gap between the main pole and the leading shield.

6. The magnetic recording head of claim 1, further comprising a facing surface facing the recording medium, wherein a distal end portion of the trailing shield and the distal end portion of the main pole are exposed in the facing surface and define the write gap in the facing surface, and the nonmagnetic film is disposed in the write gap within a positional range corresponding to 30% or more of the length of the write gap from the facing surface.

7. The magnetic recording head of claim 1, further comprising a leading shield disposed on a leading side of the main pole with a gap therebetween and a nonmagnetic film containing a nonmagnetic material with a negative thermal expansion coefficient and disposed in the gap between the main pole and the leading shield.

8. The magnetic recording head of claim 2, further comprising side shields extending from the trailing shield and located individually on both sides of the main pole in a track-width direction with gaps therebetween and a nonmagnetic film containing a nonmagnetic material with a negative thermal expansion coefficient and disposed in the gaps between the main pole and the side shields.

9. The magnetic recording head of claim 2, further comprising a leading shield disposed on a leading side of the main pole with a gap therebetween and a nonmagnetic film containing a nonmagnetic material with a negative thermal expansion coefficient and disposed in the gap between the main pole and the leading shield.

10. The magnetic recording head of claim 8, further comprising a leading shield disposed on a leading side of the main pole with a gap therebetween and a nonmagnetic film containing a nonmagnetic material with a negative thermal expansion coefficient and disposed in the gap between the main pole and the leading shield.

11. A disk drive comprising:
a recording medium comprising a magnetic recording layer;
a drive unit configured to rotate the recording medium; and
a magnetic head comprising the magnetic recording head of claim 1 and configured to perform data processing on the recording medium.

12. The disk drive of claim 11, wherein the width of the nonmagnetic film in a track-width direction, in the write gap, is greater than that of the main pole.

13. The disk drive of claim 12, further comprising a facing surface facing the recording medium, wherein a distal end portion of the trailing shield and the distal end portion of the main pole are exposed in the facing surface and define the write gap in the facing surface, and the nonmagnetic film is disposed in the write gap within a positional range corresponding to 30% or more of the length of the write gap from the facing surface.

14. The disk drive of claim 11, further comprising side shields extending from the trailing shield and located individually on both sides of the main pole in a track-width direction with gaps therebetween and a nonmagnetic film containing a nonmagnetic material with a negative thermal expansion coefficient and disposed in the gaps between the main pole and the side shields.

15. The disk drive of claim 14, further comprising a leading shield disposed on a leading side of the main pole with a gap therebetween and a nonmagnetic film containing a nonmagnetic material with a negative thermal expansion coefficient and disposed in the gap between the main pole and the leading shield.

16. The disk drive of claim 11, further comprising a facing surface facing the recording medium, wherein a distal end portion of the trailing shield and the distal end portion of the main pole are exposed in the facing surface and define the write gap in the facing surface, and the nonmagnetic film is disposed in the write gap within a positional range corresponding to 30% or more of the length of the write gap from the facing surface.

17. The disk drive of claim 11, further comprising a leading shield disposed on a leading side of the main pole with a gap therebetween and a nonmagnetic film containing a nonmagnetic material with a negative thermal expansion coefficient and disposed in the gap between the main pole and the leading shield.

18. The disk drive of claim 12, further comprising side shields extending from the trailing shield and located individually on both sides of the main pole in a track-width direction with gaps therebetween and a nonmagnetic film containing a nonmagnetic material with a negative thermal expansion coefficient and disposed in the gaps between the main pole and the side shields.

19. The disk drive of claim 12, further comprising a leading shield disposed on a leading side of the main pole with a gap therebetween and a nonmagnetic film containing a nonmagnetic material with a negative thermal expansion coefficient and disposed in the gap between the main pole and the leading shield.

20. The disk drive of claim 18, further comprising a leading shield disposed on a leading side of the main pole with a gap therebetween and a nonmagnetic film containing a nonmagnetic material with a negative thermal expansion coefficient and disposed in the gap between the main pole and the leading shield.
